(19) United States
(12) Patent Application Publication
(10) Pub. No.: US 2023/0303346 A1
(43) Pub. Date: Sep. 28, 2023

(54) TRAY OPENING/CLOSING DEVICE, INCLUDING SLIDER HAVING PLURALITY OF DIPS AND BUMPS ON BOTTOM FACE AND ENGAGING PORTION HAVING PLURALITY OF DIPS AND BUMPS ON UPPER FACE, AND IMAGE FORMING APPARATUS

(71) Applicant: KYOCERA Document Solutions Inc., Osaka (JP)

(72) Inventor: Cuong Van DO, Osaka (JP)

(73) Assignee: KYOCERA Document Solutions Inc., Osaka (JP)

(21) Appl. No.: 18/122,736

(22) Filed: Mar. 17, 2023

(30) Foreign Application Priority Data
Mar. 22, 2022 (JP) 2022-045766

(51) Int. Cl. B65H 1/04

(52) U.S. Cl. CPC B65H 1/04; B65H 2405/324; B65H 2801/06

(57) ABSTRACT

A tray opening/closing device includes a tray supported by a sidewall of an apparatus main body, so as to pivot about a shaft provided along a lower end of an opening of the sidewall, a pair of rails located on the tray, and extending in a direction orthogonal to the shaft, a slider supported by the rails, so as to move in a longitudinal direction thereof, and including a plurality of first dips and bumps formed on a bottom face thereof, and an engaging portion including a plurality of second dips and bumps formed on an upper face thereof. When the engaging portion is protruding from the rails, the first dips and bumps are engaged with a part of the second dips and bumps, and when the engaging portion is retracted under the rails, the first dips and bumps are disengaged from the part of the second dips and bumps.

### INCORPORATION BY REFERENCE

This application claims priority to Japanese Patent Application No. 2022-045766 filed on Mar. 22, 2022, the entire contents of which are incorporated by reference herein.

### BACKGROUND

The present disclosure relates to a tray opening/closing device for openably supporting a tray that opens or closes an opening in a sidewall of an apparatus main body, and to an image forming apparatus including the tray opening/closing device. In particular, the disclosure relates to a technique to simplify the opening and closing operation of the tray.

The image forming apparatus is for forming an image on a recording sheet. The image forming apparatus includes a paper feeding device that supplies the recording sheet. Examples of the paper feeding device include a paper cassette for storing a plurality of recording sheets, and a manual bypass tray. The manual bypass tray is provided in an opening in the sidewall of the apparatus main body, so as to open or close the opening, by being opened or closed.

A first image forming apparatus, configured to openably support a manual feeding tray in a storage compartment of the apparatus main body, is generally known. In the first image forming apparatus, when the user opens the manual feeding tray and sets a plurality of recording sheets thereon, a recording sheet lifting plate lifts up the leading edge of the recording sheets, and applies the leading edge of the uppermost one of the recording sheets to a feed roller, so that the feed roller draws out and delivers the recording sheet. In the first image forming apparatus, in addition, when the user closes the manual feeding tray and stores the manual feeding tray in the storage compartment of the apparatus main body, the recording sheet lifting plate rotates together with the manual feeding tray, to be accommodated inside the storage compartment, and a stopper restricts the recording sheet lifting plate from sticking out from the storage compartment.

In addition, a second image forming apparatus that includes a manual bypass tray, openably supported by the wall of the apparatus main body, is generally known. In the case of the second image forming apparatus, the user opens the manual bypass tray, and sets a plurality of recording sheets thereon. The manual bypass tray includes a tray main body on which the plurality of recording sheets are to be placed, and a lift unit. The lift unit includes a lifting plate that lifts up the portion of the recording sheet on the side of the leading edge, a lifting spring that pushes up the lifting plate, and a pair of cursors for aligning the respective side edges of the recording sheets. When the manual bypass tray is closed, a guide portion of each cursor is abutted against an opposing wall, and a portion of the lifting plate on the downstream side in the transport direction is shifted downward. Accordingly, the lifting plate smoothly moves downward, despite the manual bypass tray being closed, when the lifting plate is pushed up thus being located on the upper side. Therefore, the lifting plate is kept from interfering with a part of the apparatus main body, and the apparatus main body can be exempted from being damaged.

### SUMMARY

The disclosure proposes further improvement of the foregoing techniques.

In an aspect, the disclosure provides a tray opening/closing device including a tray, a pair of rails, a slider, and an engaging portion. The tray is supported by a sidewall of an apparatus main body, so as to pivot about a shaft provided along a lower end of an opening of the sidewall, and configured to open or close the opening, by being opened or closed. The pair of rails are located on the tray, and extend parallel to each other in a direction orthogonal to the shaft. The slider is supported by the pair of rails, so as to move in a longitudinal direction of the pair of rails. The engaging portion is configured to selectively assume, between the pair of rails, one of a state of protruding to an upper side of the pair of rails, and a state of being retracted to a lower side of the pair of rails. The slider includes a plurality of first dips and bumps formed on a bottom face thereof. The engaging portion includes a plurality of second dips and bumps formed on an upper face thereof, and extending along the longitudinal direction of the pair of rails. When the engaging portion assumes the state of protruding, the plurality of first dips and bumps are engaged with a part of the plurality of second dips and bumps, and when the engaging portion assumes the state of being retracted, the plurality of first dips and bumps are disengaged from the part of the plurality of second dips and bumps.

In another aspect, the disclosure provides an image forming apparatus including the foregoing tray opening/closing device, a feed roller, and an image forming device. The feed roller picks up and transports a recording sheet placed on the tray. The image forming device forms an image on the recording sheet transported by the sheet transport device.

### BRIEF DESCRIPTION OF THE DRAWINGS

FIG. 1 is a perspective view showing the appearance of an image forming apparatus including a tray opening/closing device according to an embodiment of the disclosure;

FIG. 2 is a perspective view showing a manual bypass tray of the tray opening/closing device, in an opened state;

FIG. 3 is a perspective view showing the tray opening/closing device;

FIG. 4 is a perspective view showing a pair of rails of the tray opening/closing device;

FIG. 5 is a perspective view showing an engaging portion of the tray opening/closing device;

FIG. 6A is a perspective view showing the engaging portion located between the pair of rails;

FIG. 6B and FIG. 6C are schematic drawings for explaining steps for locating the engaging portion between the pair of rails;

FIG. 7A is a perspective view showing a slider;

FIG. 7B is a perspective view showing the slider mounted on the pair of rails;

FIG. 8A is a cross-sectional view showing a state where dips and bumps on a main plate upper face of the engaging portion are meshed with dips and bumps on a protrusion bottom face of the slider;

FIG. 8B is an enlarged cross-sectional view of the state shown in FIG. 8A;

FIG. 8C is an enlarged cross-sectional view of the main plate of the engaging portion;

FIG. 8D is an enlarged cross-sectional view of the slider;

FIG. 9A and FIG. 9B are cross-sectional views each showing the manual bypass tray, the pair of rails, the engaging portion, and the slider;

FIG. 10A is a cross-sectional view showing a state where the dips and bumps on the main plate upper face of the engaging portion are disengaged and spaced from the dips and bumps on the protrusion bottom face of the slider;

FIG. 10B is an enlarged cross-sectional view of the state shown in FIG. 10A;

FIG. 11 is a cross-sectional view showing the manual bypass tray in the opened state;

FIG. 12 is a cross-sectional view showing a state where a lever of the engaging portion has been pressed down, on the manual bypass tray in the opened state;

FIG. 13 is a cross-sectional view showing the manual bypass tray in a half-closed state; and

FIG. 14 is a cross-sectional view showing the manual bypass tray in a closed state.

### DETAILED DESCRIPTION

Hereafter, an embodiment of the disclosure will be described, with reference to the drawings.

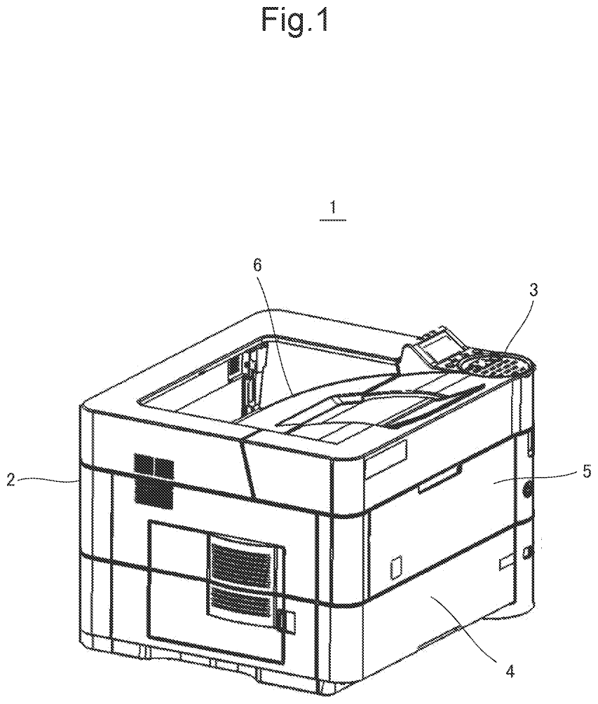

FIG. 1 is a perspective view showing the appearance of an image forming apparatus 1 including a tray opening/closing device 10 according to the embodiment of the disclosure. As shown in FIG. 1, the image forming apparatus 1 is a printer. An apparatus main body 2 includes a plurality of components for realizing various functions of the image forming apparatus 1. For example, the apparatus main body 2 includes an operation device 3, a paper cassette 4, a manual bypass tray 5, and an output tray 6. Inside the apparatus main body 2, an image forming device and a fixing device are provided.

The image forming device forms an image represented by image data, on a recording sheet supplied from the paper cassette 4 or the manual bypass tray 5, by electrophotography using toner. The recording sheet having the image formed thereon undergoes a fixing process by the fixing device, and then delivered to the output tray 6.

The operation device 3 includes, for example, a start key, an enter key for confirming an inputting operation, and numeric keys for inputting numerals. Through the operation device 3, the user's instructions to execute various operations and processings are inputted. The operation device 3 also includes a display device for displaying, for example, operation guides for the user.

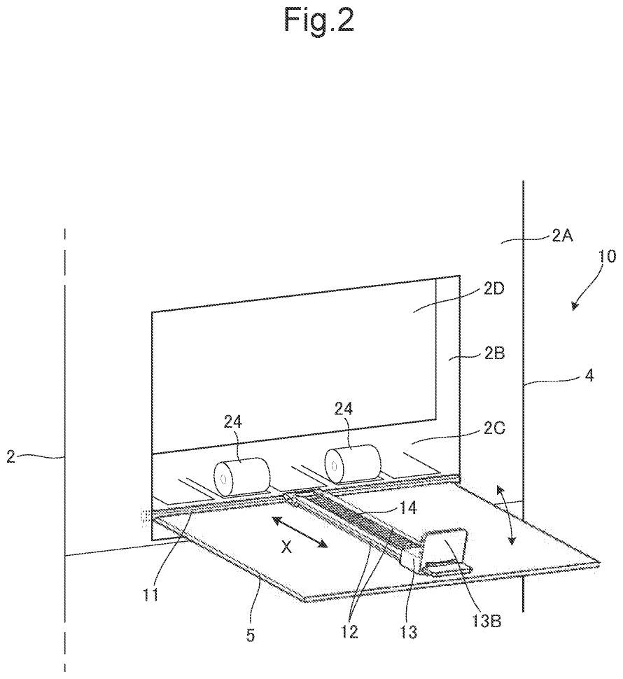

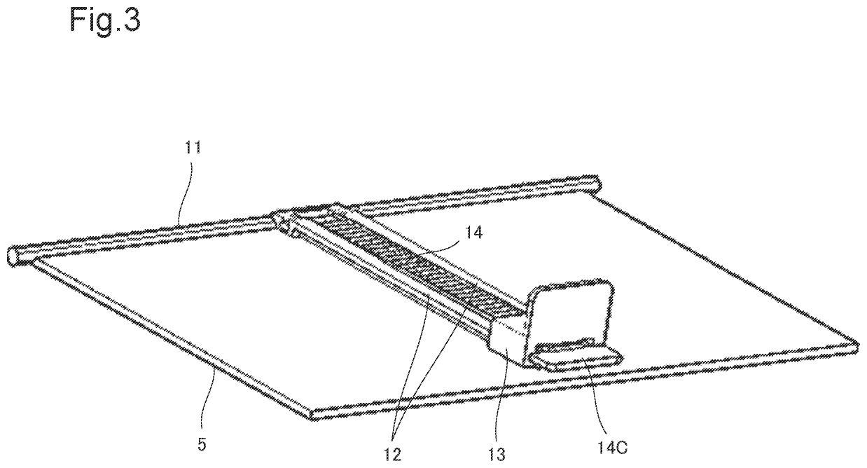

FIG. 2 is a perspective view showing the manual bypass tray 5 of the tray opening/closing device 10, in the opened state. FIG. 3 is a perspective view showing the tray opening/closing device 10.

On the tray opening/closing device 10, the manual bypass tray 5 is openably provided in a cavity 2B in a sidewall 2A of the apparatus main body 2. In the upper region of the cavity 2B of the sidewall 2A, a wall portion 2D is provided. In the lower region of the cavity 2B of the sidewall 2A, an opening 2C communicating with the inside of the apparatus main body 2 is provided. The manual bypass tray 5 is pivotably supported by a shaft 11, provided along the lower end portion of the opening 2C. In other words, the manual bypass tray 5 is supported by the sidewall 2A, so as to pivot about the shaft 11. The shaft 11 is provided along the lower end portion of the sidewall 2A. The manual bypass tray 5 can be made to protrude from the cavity 2B, or accommodated in the cavity 2B, by being opened or closed. In other words, the manual bypass tray 5 opens up or closes the opening 2C, by being opened or closed.

On the manual bypass tray 5, a pair of rails 12, a slider 13, and an engaging portion 14 are provided. The pair of rails 12 extend parallel to each other, in a direction X extending in a direction orthogonal to the lower end portion of the sidewall 2A and the shaft 11, and intersecting the opening 2C. The slider 13 is supported by the pair of rails 12, so as to move in the longitudinal direction of the pair of rails 12 (same as direction X). The engaging portion 14 selectively assumes, between the pair of rails 12, one of a state of protruding to the upper side of the pair of rails 12, and a state of being retracted to the lower side of the pair of rails 12.

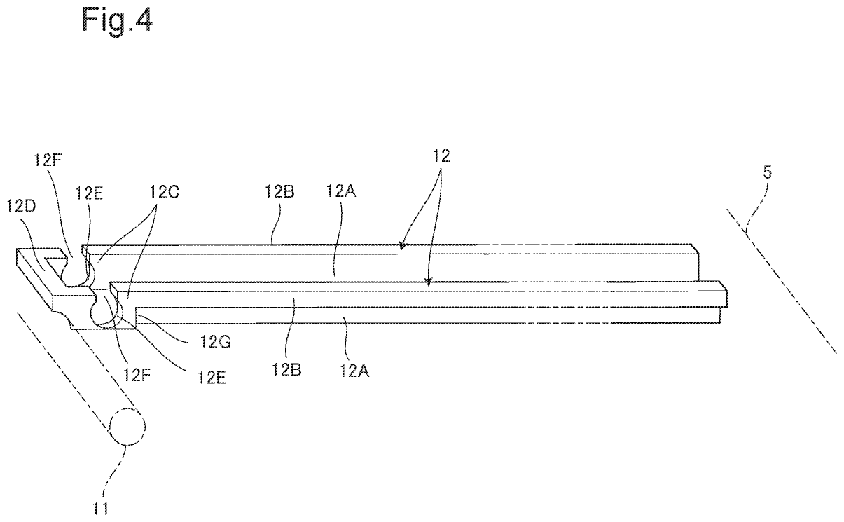

FIG. 4 is a perspective view showing the pair of rails 12. As shown in FIG. 4, the rails 12 each include a vertical wall 12A, a guide portion 12B, and a support wall 12C. The vertical wall 12A is erected on the manual bypass tray 5. The guide portion 12B is protruding outward from the upper portion of the vertical wall 12A. The support wall 12C is formed at an end portion of the rail 12 (end portion in the direction X). The respective support walls 12C of the pair of rails 12 are connected to each other via a joint portion 12D. The joint portion 12D is in contact with the shaft 11.

The support walls 12C each include a fitting hole 12E, a cutaway portion 12F, and a stopper 12G. The cutaway portion 12F is continuous with the fitting hole 12E, via the upper portion of the support wall 12C. The stopper 12G is for delimiting the movement of the slider 13.

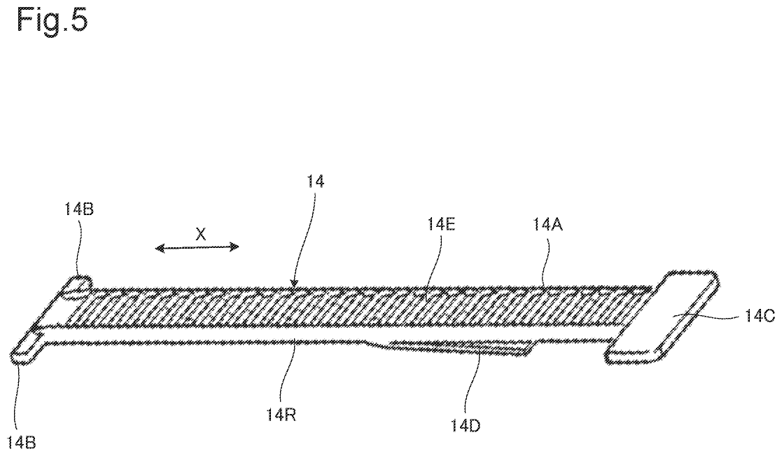

FIG. 5 is a perspective view showing the engaging portion 14. As shown in FIG. 5, the engaging portion 14 includes a main plate 14A of a rectangular shape, support shafts 14B, a lever 14C, and an arm 14D. The main plate 14A is located between the pair of rails 12. The support shafts 14B are protruding from an end portion of the main plate 14A, to the respective sides. The lever 14C is formed on the other end portion of the main plate 14A (the other end portion in the direction X). The arm 14D is protruding obliquely backward from the back face of the main plate 14A. The main plate 14A includes a plurality of dips and bumps 14E formed on the upper face thereof, in alignment along the direction X. On each side of the main plate 14A, a reinforcing rib 14R is provided to prevent distortion of the main plate 14A.

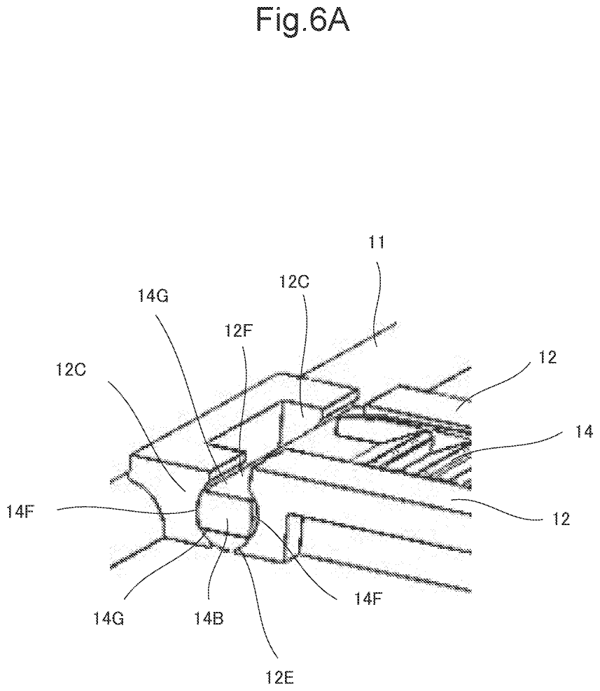

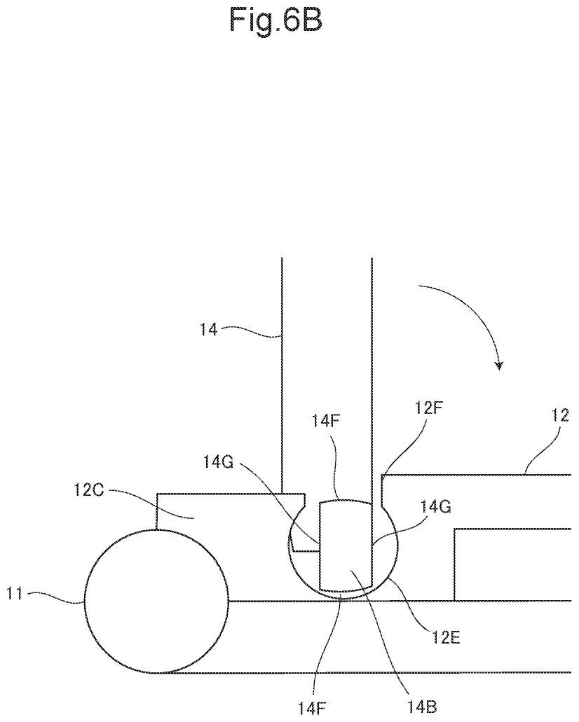

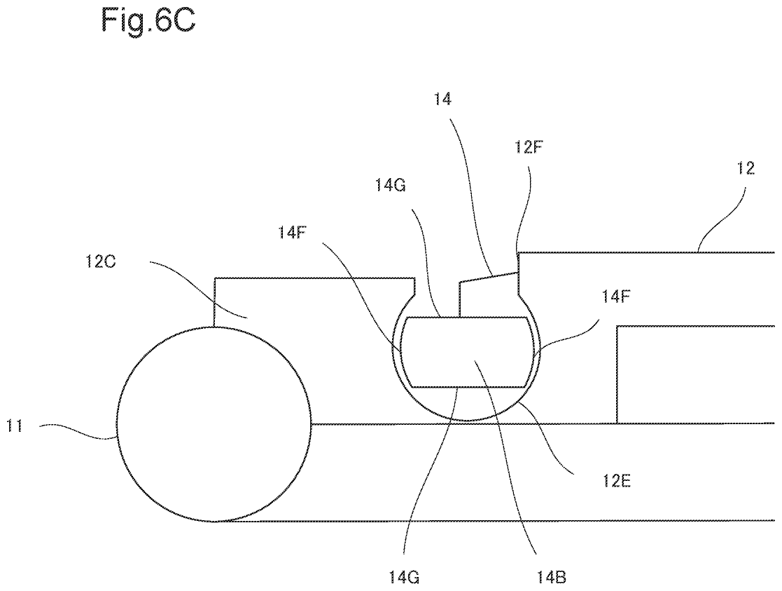

As shown in FIG. 6A, the support shafts 14B of the engaging portion 14 are each inserted in the fitting hole 12E of the support wall 12C of the rail 12, thus to be rotatably supported. The support shafts 14B each have a generally square columnar shape. A pair of opposing walls 14F of the square column are each formed as a roundish surface, having an arcuate cross-sectional shape. The other pair of opposing walls 14G of the square column are each formed as a flat surface. The distance between the pair of opposing walls 14F is wider than the distance between the other pair of opposing walls 14G.

Referring to FIG. 6B, when the engaging portion 14 is to be located between the pair of rails 12, first the engaging portion 14 is erected on the rails 12. Then the flat pair of opposing walls 14G of each of the support shafts 14B of the engaging portion 14 are passed in the cutaway portion 12F in the support wall 12C of the rail 12, and the support shafts 14B are each inserted in the corresponding fitting hole 12E of the support wall 12C. When the engaging portion 14 is laid down and fitted between the pair of rails 12, the pair of opposing walls 14F of each of the support shafts 14B make sliding contact with the inner circumferential surface of the fitting hole 12E of the support wall 12C, as shown in FIG. 6C, so that the support shafts 14B are rotatably supported. The distance between the pair of opposing walls 14F of each of the support shafts 14B is wider than the width of the cutaway portion 12F of the support wall 12C of the rail 12. Therefore, the support shafts 14B are prevented from coming off from the fitting hole 12E of the support wall 12C.

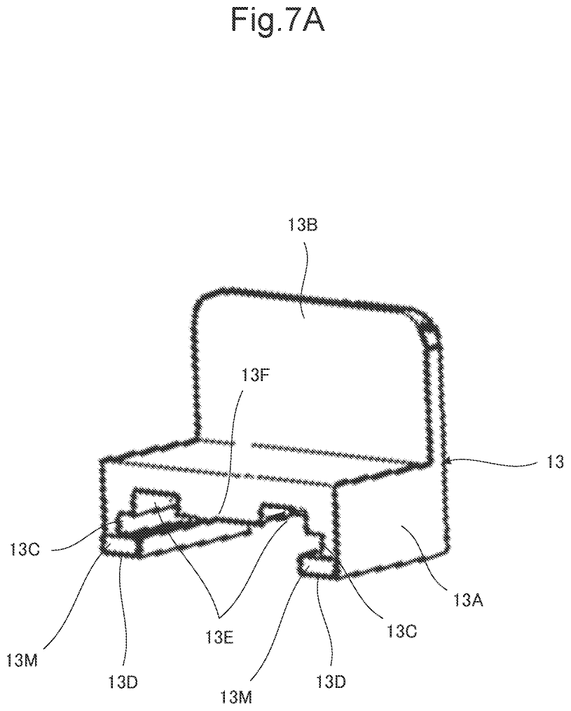

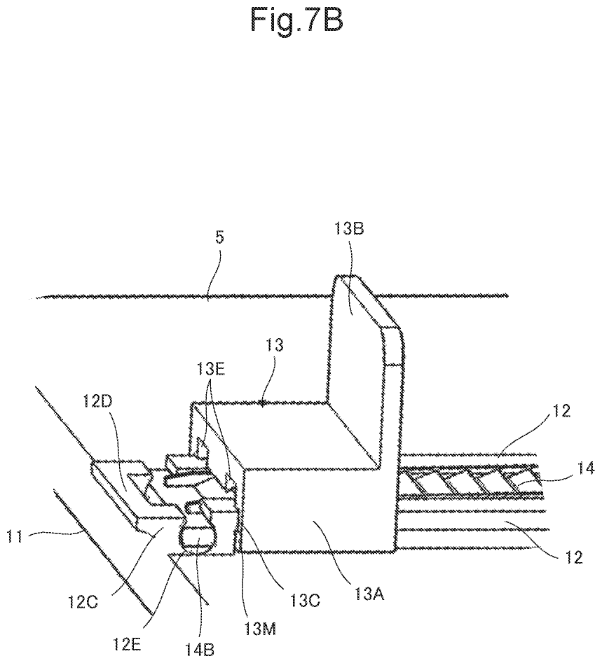

As shown in FIG. 7A and FIG. 7B, the slider 13 includes a pedestal 13A and a knob 13B. The knob 13B is protruding upward, from the rear end of the pedestal 13A. Inside the pedestal 13A, a pair of guide grooves 13C, a pair of bottom edges 13D, a pair of recesses 13E, and a protrusion 13F are provided. The pair of guide grooves 13C are opposed to each other in the horizontal direction. The bottom edges 13D are formed on the lower side of the respective guide grooves 13C. The pair of recesses 13E are open toward the lower side. The protrusion 13F is formed between the pair of recesses 13E. To the end face of each of the bottom edges 13D (portion to be abutted against the stopper 12G), a buffer material 13M is adhered.

As shown in FIG. 7B, the slider 13 is mounted from the side of the rear end of the rails 12, which is open. The slider 13 can be mounted on the rails 12, by inserting the rear end portion of the guide portions 12B of the rails 12, into the respective guide grooves 13C in the pedestal 13A of the slider 13.

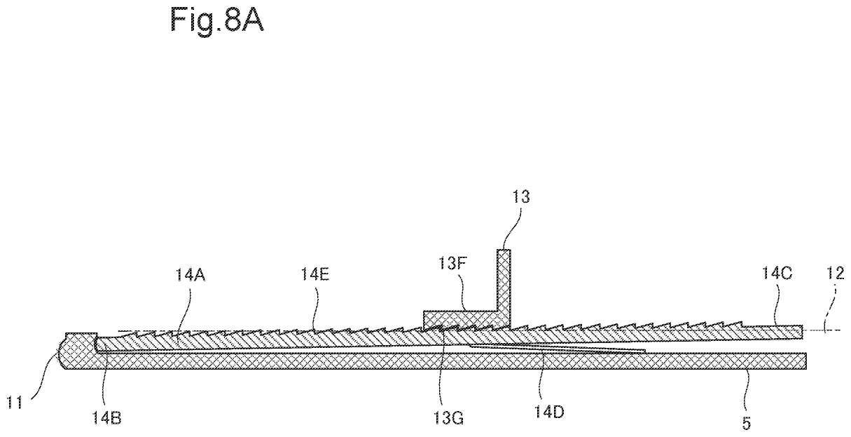

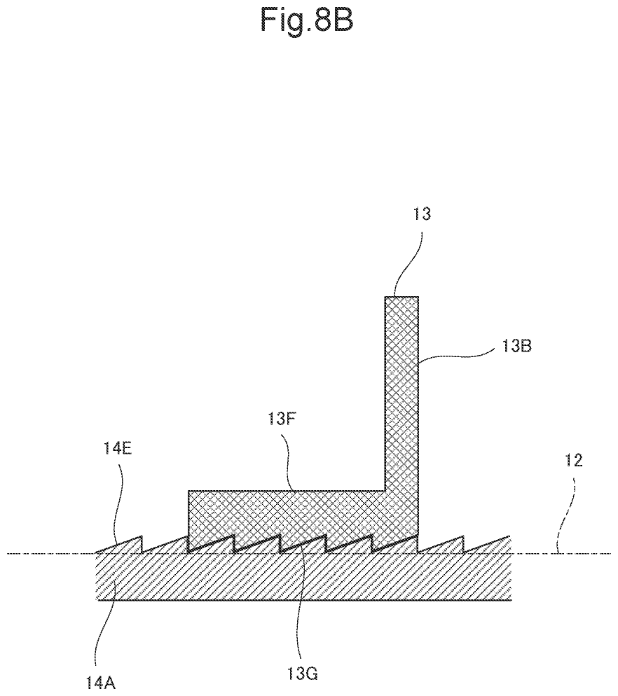

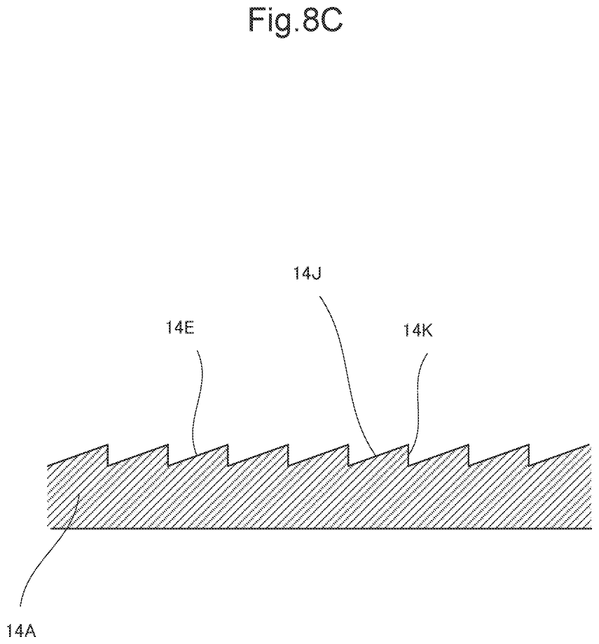

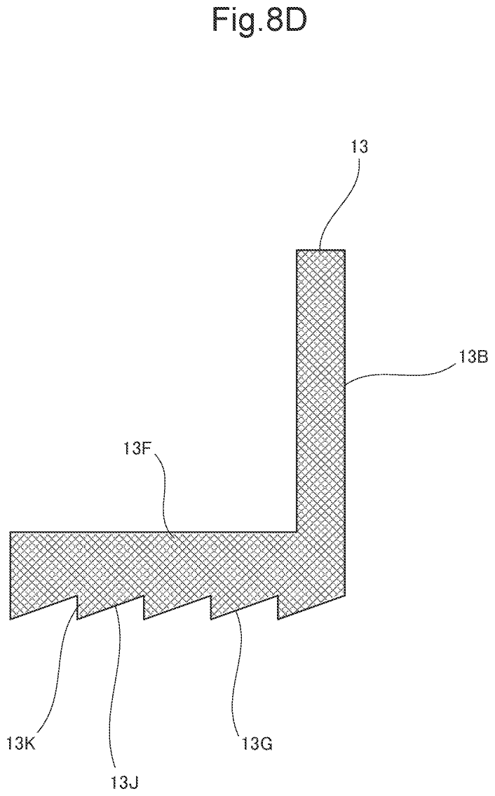

As shown in FIG. 8A and FIG. 8B, a plurality of dips and bumps 13G are formed on the bottom face of the protrusion 13F in the pedestal 13A of the slider 13. From the lower face of the main plate 14A of the engaging portion 14 located between the pair of rails 12, the arm 14D is protruding obliquely backward. The arm 14D is in contact with the upper face of the manual bypass tray 5, and lifts up the dips and bumps 14E of the main plate 14A to the upper side of the upper face of the rails 12. In other words, the arm 14D biases the engaging portion 14 upward, thereby making the engaging portion 14 protrude to the upper side of the pair of rails 12. Thus, the arm 14D serves to enable a part of the plurality of dips and bumps 14E of the main plate 14A to be securely engaged with the plurality of dips and bumps 13G formed on the bottom face of the protrusion 13F of the slider 13.

As shown in FIG. 8C, the dips and bumps 14E of the main plate 14A of the engaging portion 14 have a triangular wave form, including sloped surfaces 14J and orthogonal surfaces 14K alternately aligned. The sloped surface 14J is oriented to the opening 2C. and inclined with respect to the upper face of the rails 12. The orthogonal surface 14K is oriented to the opposite side of the opening 2C, and orthogonal to the upper face of the rails 12.

As shown in FIG. 8D, the dips and bumps 13G on the bottom face of the protrusion 13F of the slider 13 have a triangular wave form, including sloped surfaces 13J and orthogonal surfaces 13K alternately aligned. The sloped surface 13J is oriented to the opposite side of the opening 2C, and inclined with respect to the bottom face of the protrusion 13F. The orthogonal surface 13K is oriented to the opening 2C, and orthogonal to the bottom face of the protrusion 13F.

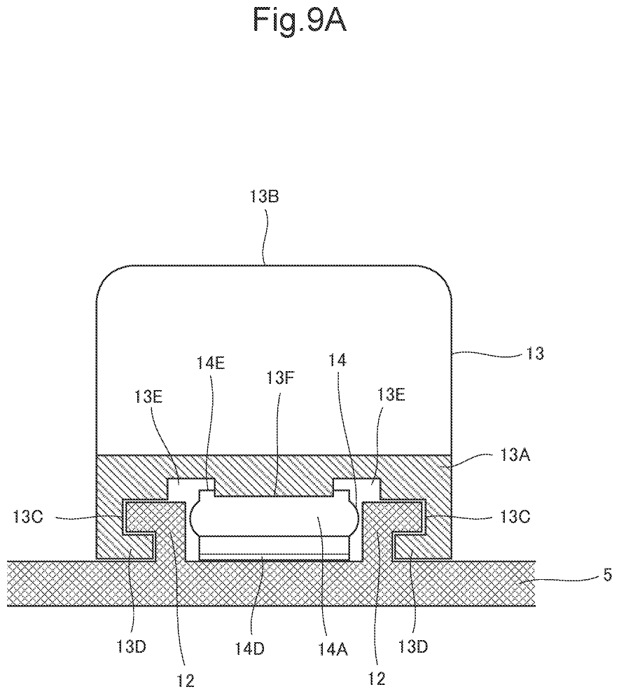

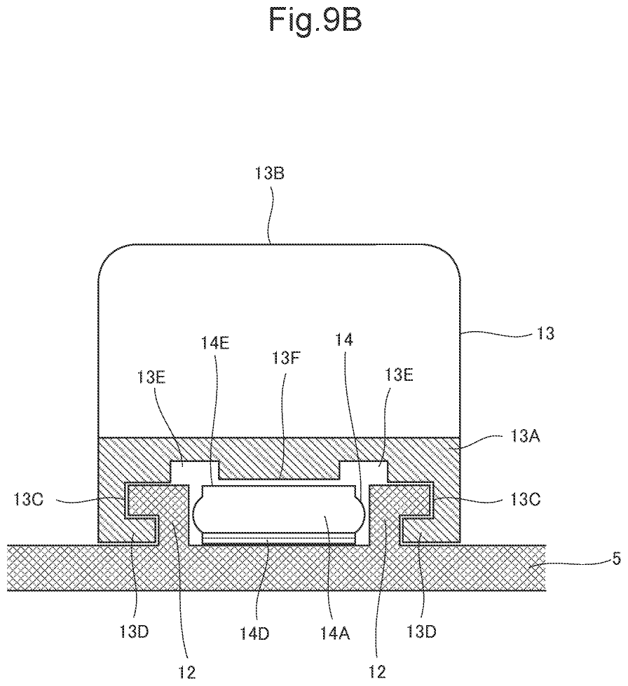

FIG. 9A is a cross-sectional view showing the manual bypass tray 5, the pair of rails 12, the main plate 14A of the engaging portion 14, and the slider 13. FIG. 9A illustrates the state where the dips and bumps 14E of the main plate 14A are made to protrude to the upper side of the upper face of the pair of rails 12, and engaged with the dips and bumps 13G on the bottom face of the protrusion 13F of the slider 13. Thus, when the engaging portion 14 assumes the protruding state, the plurality of dips and bumps 13G of the slider 13 are engaged with a part of the plurality of dips and bumps 14E of the engaging portion 14.

As shown in FIG. 8A, FIG. 8B, and FIG. 9A, when the dips and bumps 14E on the main plate 14A of the engaging portion 14 are engaged with the dips and bumps 13G of the slider 13, the orthogonal surfaces 14K of the dips and bumps 14E are opposed to the orthogonal surfaces 13K of the dips and bumps 13G, and therefore the slider 13 is unable to be moved toward the opening 2C.

In addition, the sloped surfaces 14J of the dips and bumps 14E are also opposed to the sloped surfaces 13J of the dips and bumps 13G. Accordingly, when the knob 13B of the slider 13 is pulled in the direction away from the opening 2C, the sloped surfaces 13J of the dips and bumps 13G press the sloped surfaces 14J of the dips and bumps 14E downward, thereby causing elastic deformation of the arm 14D on the back face of the main plate 14A. As result, the sloped surfaces 13J of the dips and bumps 13G each step over the corresponding sloped surface 14J of the dips and bumps 14E, and therefore the slider 13 can be moved in the direction away from the opening 2C.

Thus, the slider 13 can be moved in the direction away from the opening 2C, though the slider 13 is unable to be moved toward the opening 2C.

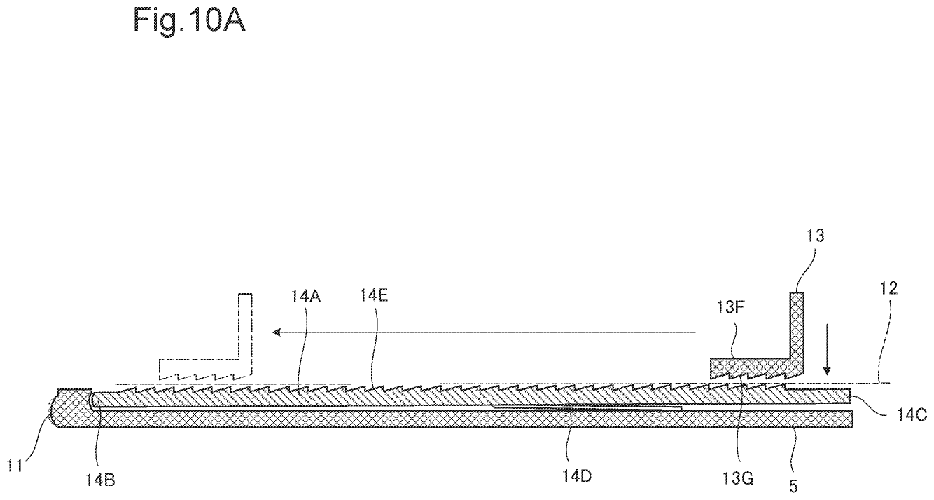

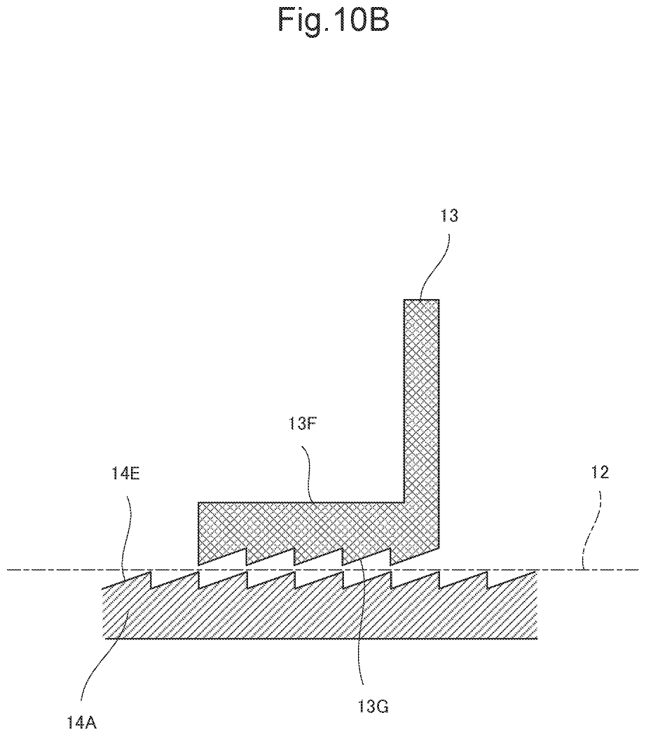

Referring to FIG. 10A and FIG. 10B, the lever 14C of the main plate 14A of the engaging portion 14 is used to press down the engaging portion 14 to the lower side of the pair of rails 12, against the biasing force of the arm 14D. When the user presses down the lever 14C, the main plate 14A is made to pivot about the support shafts 14B, located at the end portion of the main plate 14A. Therefore, the dips and bumps 14E on the main plate 14A are retracted to the lower side of the upper face of the rails 12, and the dips and bumps 14E are spaced and disengaged from the dips and bumps 13G on the bottom face of the protrusion 13F of the slider 13. In other words, when the engaging portion 14 assumes the retracted state, the plurality of dips and bumps 13G are disengaged from a part of the plurality of dips and bumps 14E. In this case, since the main plate 14A is reinforced by the ribs 14R provided on the respective sides of the main plate 14A, the main plate 14A is prevented from being distorted, so that the dips and bumps 14E can be surely disengaged from the dips and bumps 13G. In this state, the slider 13 can be moved toward the opening 2C.

FIG. 9B is another cross-sectional view showing the manual bypass tray 5, the pair of rails 12, the main plate 14A of the engaging portion 14, and the slider 13. FIG. 9B illustrates a state where the dips and bumps 14E on the main plate 14A of the engaging portion 14 are retracted to the lower side of the upper face of the rails 12, and disengaged from the dips and bumps 13G on the bottom face of the protrusion 13F of the slider 13.

As described above, to mount the slider 13 from the side of the open rear end of the rails 12, first the user presses down the lever 14C of the main plate 14A of the engaging portion 14, thereby enabling the slider 13 to move toward the opening 2C. Then the user inserts the rear end of the guide portion 12B of the rails 12 into the guide groove 13C in the pedestal 13A of the slider 13, and moves the slider 13 to a desired position.

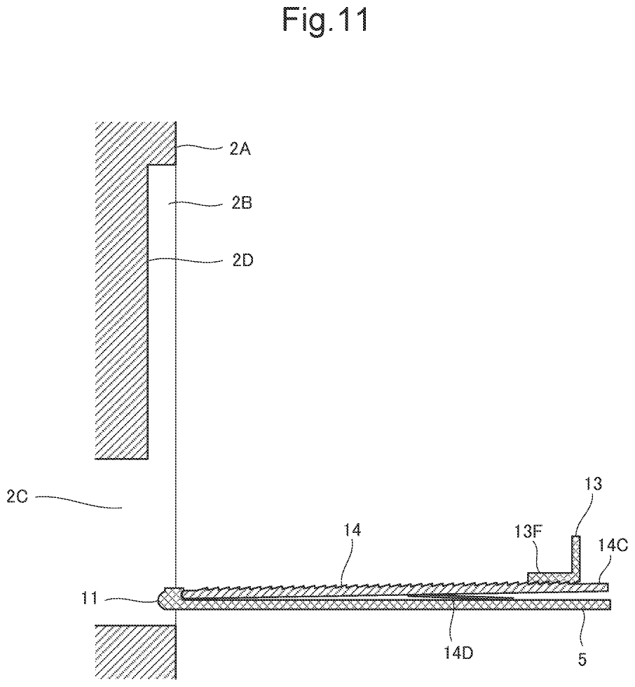

With the tray opening/closing device 10 configured as above, first the user opens the manual bypass tray 5 to thereby open up the opening 2C of the apparatus main body 2, as shown in FIG. 2. The user pulls the knob 13B of the slider 13 in the direction away from the opening 2C, thereby moving the slider 13 away from the opening 2C, and places a plurality of recording sheets on the manual bypass tray 5. Then the user presses down the lever 14C of the main plate 14A of the engaging portion 14, thereby disengaging the dips and bumps 14E on the main plate 14A from the dips and bumps 13G of the slider 13, as shown in FIG. 10A, FIG. 10B, and FIG. 9B. In this state, the user moves the slider 13 toward the opening 2C, so as to bring the pedestal 13A of the slider 13 into contact with the trailing edge of the recording sheets. The user then releases the lever 14C, thereby allowing the dips and bumps 14E on the main plate 14A to be engaged with the dips and bumps 13G on the slider 13, as shown in FIG. 8A, FIG. 8B, and FIG. 9A, so that the slider 13 is set in position as shown in FIG. 11. Thus, the trailing edges of the respective recording sheets are aligned, and the leading edges of the respective recording sheets are inserted in the position under the feed rollers 24 provided inside the opening 2C. When the feed rollers 24 rotate in this state, the recording sheets are sequentially transported by the feed rollers 24, toward the image forming device located inside the apparatus main body 2. The image forming device sequentially forms the images on the respective recording sheets.

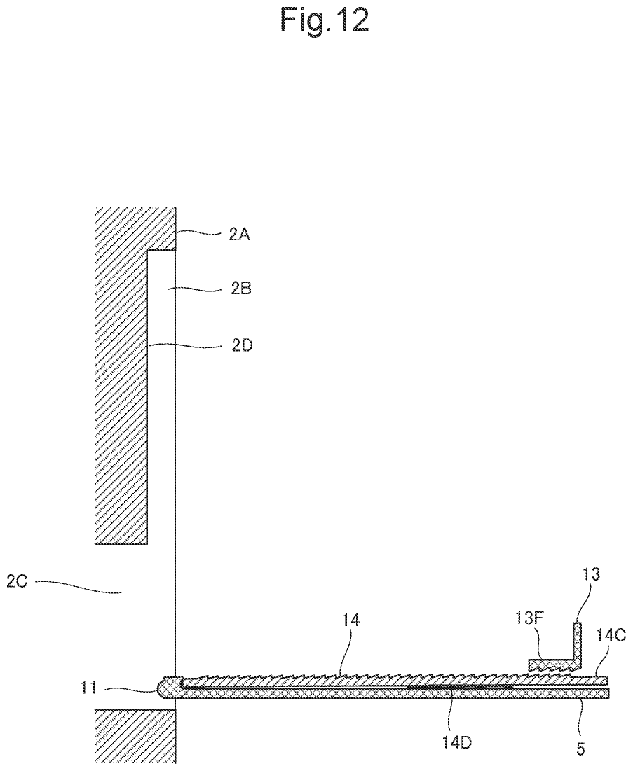

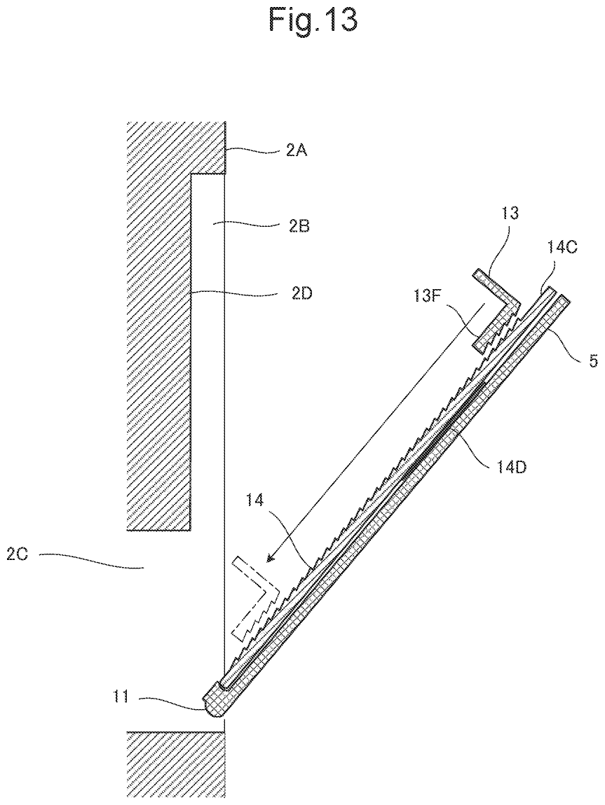

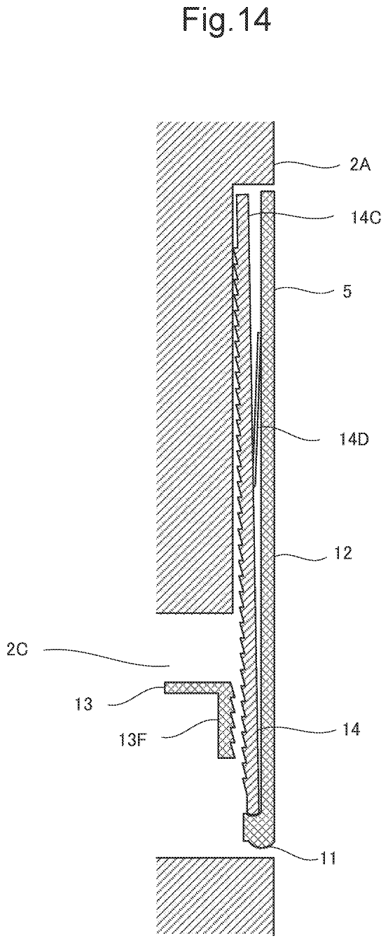

When the manual bypass tray 5 is to be closed, so as to close the opening 2C of the apparatus main body 2, the user presses down the lever 14C of the main plate 14A of the engaging portion 14, to thereby disengage the dips and bumps 14E on the main plate 14A from the dips and bumps 13G of the slider 13, as shown in FIG. 12. As result, the slider 13 becomes movable toward or away from the opening 2C. When the user gradually closes the manual bypass tray 5 in this state, the slider 13 slides down toward the opening 2C along the rails 12, owing to the self-weight, as shown in FIG. 13. Finally the slider 13 abuts against the stopper 12G of the rails 12 and stops at a predetermined position, as shown in FIG. 7B. More specifically, the bottom edges 13D of the slider 13 abut against the stopper 12G of the respective rails 12, via the buffer material 13M. Therefore, the impact noise originating from the abutting action is reduced. When the user completely closes the manual bypass tray 5, the slider 13 is accommodated inside the opening 2C, as shown in FIG. 14. Therefore, the slider 13 is prevented from colliding with the wall portion 2D in the recess 2B, and exempted from being damaged.

Now, there are cases where a slider for aligning the trailing edges of the respective recording sheets placed on the manual bypass tray is provided on the manual bypass tray. Such a slider is movable in the longitudinal direction of the recording sheets on the manual bypass tray. The slider is made to abut against the trailing edge of the recording sheet, and stops at that position. The slider has to be moved to the predetermined position, before the manual bypass tray is closed. When the manual bypass tray is closed, without the slider having been moved to the predetermined position, the slider interferes with the apparatus main body.

In the case of the aforementioned first image forming apparatus, the recording sheet lifting plate rotates together with the manual feeding tray, at the same time that the manual feeding tray is closed, and is accommodated in the storage compartment. In the case of the second image forming apparatus, the portion of the lifting plate on the downstream side in the transport direction moves downward, at the same time that the manual bypass tray is closed, so that the interference between the lifting plate and a part of the apparatus main body can be avoided.

However, neither the first image forming apparatus nor the second image forming apparatus includes the slider configured as above. Therefore, those image forming apparatuses do not provide the technique to restrict the slider from interfering with the apparatus main body, when the manual bypass tray is closed.

In contrast, with the tray opening/closing device 10 according to the foregoing embodiment, when the user presses down the lever 14C of the engaging portion 14, at the time of closing the manual bypass tray 5, the slider 13 becomes free to move toward or away from the opening 2C, and slides down toward the opening 2C of the apparatus main body 2 along the rails 12. Therefore, the slider 13 can be kept from interfering with the wall portion 2D of the apparatus main body 2, without the need to take the trouble to move the slider 13.

In the foregoing embodiment, the buffer material 13M is provided on the respective end faces of the bottom edges 13D of the slider 13. Instead, the buffer material may be provided on the respective stoppers 12G of the rails 12.

Although the image forming apparatus 1 is exemplified by the printer in the foregoing embodiment, the image forming apparatus 1 may be a multifunction peripheral, a copier, or a facsimile machine.

The configurations of the foregoing embodiment, described with reference to FIG. 1 to FIG. 14, are merely exemplary, and in no way intended to limit the disclosure to those configurations.

While the present disclosure has been described in detail with reference to the embodiments thereof, it would be apparent to those skilled in the art the various changes and modifications may be made therein within the scope defined by the appended claims.

What is claimed is:

1. A tray opening/closing device comprising:
a tray supported by a sidewall of an apparatus main body, so as to pivot about a shaft provided along a lower end of an opening of the sidewall, and configured to open or close the opening, by being opened or closed;
a pair of rails located on the tray, and extending parallel to each other in a direction orthogonal to the shaft;
a slider supported by the pair of rails, so as to move in a longitudinal direction of the pair of rails; and
an engaging portion configured to selectively assume, between the pair of rails, one of a state of protruding to an upper side of the pair of rails, and a state of being retracted to a lower side of the pair of rails,
wherein the slider includes a plurality of first dips and bumps formed on a bottom face thereof,
the engaging portion includes a plurality of second dips and bumps formed on an upper face thereof, and extending along the longitudinal direction of the pair of rails, and
when the engaging portion assumes the state of protruding, the plurality of first dips and bumps are engaged with a part of the plurality of second dips and bumps, and when the engaging portion assumes the state of being retracted, the plurality of first dips and bumps are disengaged from the part of the plurality of second dips and bumps.

2. The tray opening/closing device according to claim 1,
wherein the engaging portion includes an elastic member provided on a lower face, and configured to bias the engaging portion upward and make the engaging portion protrude to an upper side of the pair of rails, and
the engaging portion includes a lever provided on an end portion in the longitudinal direction, and configured to retract the engaging portion to a lower side of the pair of rails, against biasing force of the elastic member.

3. The tray opening/closing device according to claim 1,
wherein the pair of rails each include a stopper located at least on one end portion in the longitudinal direction, and against which the slider is to abut, and
a buffer material is provided on the stopper, or a portion of the slider to abut against the stopper.

4. The tray opening/closing device according to claim 1,
wherein the plurality of second dips and bumps of the engaging portion have a triangular wave form, including sloped surfaces and orthogonal surfaces alternately aligned, the sloped surface being oriented to the opening, and inclined with respect to an upper face of the pair of rails, and the orthogonal surface being oriented to an opposite side of the opening, and orthogonal to the upper face of the pair of rails, and
the plurality of dips and bumps of the slider have a triangular wave form, including sloped surfaces and orthogonal surfaces alternately aligned, the sloped surface being oriented to the opposite side of the opening, and inclined with respect to the upper face of the pair of rails, and the orthogonal surface being oriented to the opening, and orthogonal to the upper face of the pair of rails.

5. The tray opening/closing device according to claim 2,
wherein the engaging portion includes a main plate on an upper face of which the plurality of second dips and bumps are formed, and ribs provided on respective sides of the main plate.

6. An image forming apparatus comprising:
the tray opening/closing device according to claim 1;
a feed roller that picks up and transports a recording sheet placed on the tray; and
an image forming device that forms an image on the recording sheet transported by the feed roller.
